(19) United States
(12) Patent Application Publication
(10) Pub. No.: US 2013/0082921 A1
(43) Pub. Date: Apr. 4, 2013

(54) BARRIER PANEL, AND 3D IMAGE DISPLAY DEVICE AND METHOD USING THE SAME

(71) Applicant: Soon Seok KANG, Gyeonggi-do (KR)

(72) Inventor: Soon Seok KANG, Gyeonggi-do (KR)

(21) Appl. No.: 13/619,864

(22) Filed: Sep. 14, 2012

(30) Foreign Application Priority Data
Sep. 30, 2011 (KR) 10-2011-0099536

(51) Int. Cl. G06F 3/01; G02B 27/22

(52) U.S. Cl. 345/156; 359/462

(57) ABSTRACT

A barrier panel, and a 3D image display device and method are provided. The barrier panel is disposed corresponding to an image panel including a plurality of pixels and is configured such that M×N barrier regions of the barrier panel are formed at each pixel of the image panel. The brightness of each barrier region is adjusted to display a 3D image from the image panel.

### CROSS-REFERENCE TO RELATED APPLICATIONS

This application claims the benefit of Korean Patent Application No. 10-2011-0099536 filed with the Korea Intellectual Property Office on Sep. 30, 2011, the disclosure of which is incorporated herein by reference.

### BACKGROUND OF THE INVENTION

1. Field of the Invention

The present invention relates to a barrier panel, and a 3D image display device and method using the same, and more particularly, to a barrier panel having a plurality of barrier regions, whose brightness is adjusted, and a 3D image display device and method using the same.

2. Description of the Related Art

As compared to 3D image processing market, 3D display market is slow in progress. The development of display market has been mainly focused only on image display, while excluding information on observers. One of the biggest reasons is that it is difficult to reproduce a 3D image based on an observer's viewpoint.

Current 3D mobile phones displays 3D images using a fixed barrier type glassless 3D liquid crystal panel. However, even in the case of the same image, if a distance between an observer and an image panel and an angle of view are changed, a 3D image may also be changed. For example, even a well-displayed image may look blurry or disappeared. Different barriers need to be used when providing an image to a person who views a 3D image in front of an image panel at a distance of about 30 cm and a person who views a 3D image at an angle of 30 degrees at a distance of 30 cm. However, since a conventional barrier is a fixed type, only a person being in front of an image panel may view a high-quality 3D image.

Conventionally, a fixed barrier type image panel in which a barrier film is fixed on a liquid crystal panel has been used. A barrier is switched on/off, focusing on an observer being in front of the panel. Therefore, if an observer deviates from the view of angle slightly (about 3degrees from the front direction), even a high-quality 3D image may look blurry or disappeared.

### SUMMARY OF THE INVENTION

The present invention has been invented in order to overcome the above-described problems and it is, therefore, an object of the present invention to provide a barrier panel, and a 3D image display device and method, in which the barrier panel is divided into M×N barrier regions per one pixel of an image panel, and the brightness of the M×N barrier regions is adjusted, thereby implementing a multi-view 3D image display.

In accordance with one aspect of the present invention to achieve the object, there is provided a barrier panel, characterized in that the barrier panel is disposed corresponding to an image panel including a plurality of pixels and is configured so that M×N barrier regions per pixel of the image panel are formed, wherein the brightness of each barrier region is respectively adjusted for a 3D image to be displayed from the image panel.

The brightness of each barrier region may be controlled to have an on level, an off level, and at least one middle brightness level between the on level and the off level.

The number (M) of rows and the number (N) of columns in the M×N barrier regions may be respectively equal to or greater than 1.

The number (N) of the columns in the M×N barrier regions may be equal to or greater than 2.

In accordance with another aspect of the present invention to achieve the object, there is provided a 3D image display device, which includes: an image panel configured to include a plurality of pixels and display an image for 3D image; a barrier panel disposed in a front or rear side of the image panel and configured to include M×N barrier regions per pixel of the image panel, wherein brightness is adjusted by each barrier region; and a control unit configured to adjust the brightness of each barrier region so that the 3D image is displayed from the image panel.

The barrier panel may be controlled by the control unit to have an on level, an off level, and at least one middle level, such that the brightness of each barrier region is adjusted in at least three levels.

The number (M) of rows and the number (N) of columns in the M×N barrier regions may be respectively equal to or greater than 1.

The number (M) of the rows may be equal to or greater than 1, and the number (N) of the columns may be equal to or greater than 2.

The 3D image display device may further include a tracking system configured to acquire an image of an observer region and extract observation position information of the observer, wherein the control unit is configured to adjust the brightness of each barrier region of the barrier panel according to the observation position information so that the 3D image of the image panel is exposed to the observation position of the observer.

The tracking system may include: a camera module configured to acquire the image of the observer region; and a tracking unit configured to calculate a position(s) and distance(s) of the observer's two eyes as the observation position information by using the acquired image. The control unit may be configured to acquire a control value for controlling the brightness of each barrier region from the position and distance information of the observer's two eyes and adjust the brightness of each barrier region according to the acquired control value.

In accordance with another aspect of the present invention to achieve the object, there is provided a 3D image display method, characterized in that a 3D image is displayed from an image panel by adjusting brightness of M×N barrier regions formed in a barrier panel, based on position information of an observer, wherein the barrier panel is disposed corresponding to the image panel including a plurality of pixels so that the M×N barrier regions per pixel of the image panel are formed.

The 3D image display method may include: performing a position tracking step of acquiring an image of an observer region and extracting observation position information of the observer; and performing a barrier controlling step of controlling that the 3D image of the image panel is displayed to the observer, by adjusting the brightness of each barrier region according to the observation position information, wherein the barrier panel is disposed corresponding to a front or rear side of the image panel.

In the barrier controlling step, the brightness of each barrier region may be controlled to have an on level, an off level, and at least one middle level, such that the brightness of each barrier region is adjusted in at least three levels.

The position tracking step may include: acquiring the image of the observer region; and acquiring a position(s) and distance(s) of the observer's two eyes as the observation position information by using the acquired image. The barrier controlling step may include: acquiring a control value for controlling the brightness of each barrier region from the position and distance information of the observer's two eyes; and adjusting the brightness of each barrier region according to the control value so that the 3D image of the image panel is exposed to the observer's two eyes.

The barrier panel may be configured to form M×N barrier regions per one pixel of the image panel, in which the number (M) of rows and the number (N) of columns in the M×N barrier regions are respectively equal to or greater than 1.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view of a barrier panel in accordance with an embodiment of the present invention;

FIG. 2 is a schematic view of a 3D image display device in accordance with an embodiment of the present invention;

FIG. 3 is a block diagram of a 3D image display device in accordance with another embodiment of the present invention;

FIG. 4 is a flowchart showing a 3D image display method in accordance with an embodiment of the present invention; and

FIG. 5 is a flowchart showing a 3D image display method in accordance with another embodiment of the present invention.

### DETAILED DESCRIPTION OF THE PREFERABLE EMBODIMENTS

Embodiments of the present invention for achieving the above objects will be described with reference to the accompanying drawings. In the specification, like reference numerals denote like elements, and duplicate or redundant descriptions will be omitted for conciseness.

It will be understood that when an element is referred to as being ‘connected to’ or ‘coupled to’ another element, it may be directly connected or coupled to the other element or at least one intervening element may be present therebetween. In contrast, when an element is referred to as being ‘directly connected to’ or ‘directly coupled to’ another element, there are no intervening element therebetween. Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. The same is true of the case of terms implying the meaning of ‘contact’, such as ‘on’, ‘over’, ‘beneath’ and ‘under’. Directional terms, if their relevant elements are turned over, may be interpreted as implying relative directions.

It should be noted that the singular forms ‘a’ ‘an’ and ‘the’ are intended to include the plural forms as well, unless the context clearly indicates otherwise. It should be understood that the terms ‘comprise’, ‘include’ and ‘have’, when used in this specification, specify the presence of stated features or elements, but do not preclude the presence or addition of one or more other features, elements, or combinations thereof.

The accompanying drawings are ideal or abstract illustrations for describing the embodiments of the present invention, in which structural features such as shape, size and thickness may be exaggerated for effective description of technical features.

First, a barrier panel in accordance with a first embodiment of the present invention will be described in detail with reference to the accompanying drawing.

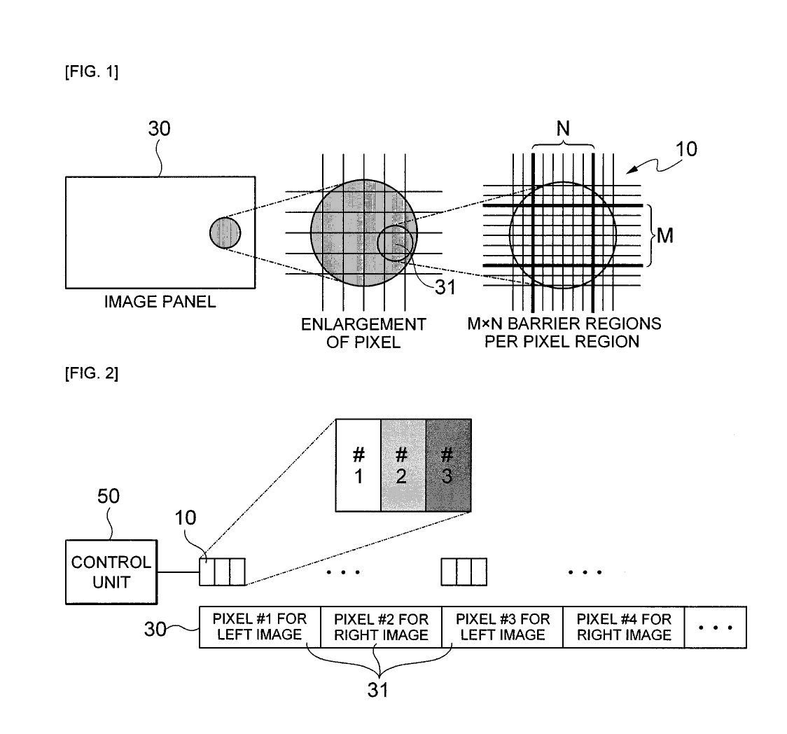

FIG. 1 is a schematic view of a barrier panel in accordance with an embodiment of the present invention, and FIG. 2 is a schematic view of an image display device including a barrier panel in accordance with an embodiment of the present invention.

Referring to FIG. 1, a barrier panel 10 in accordance with an embodiment of the present invention is disposed corresponding to an image panel 30 having a plurality of pixels. The barrier panel 10 may be disposed in the front or rear side of the image panel 30.

The barrier panel 10 is configured such that M×N barrier regions are formed at each pixel 31 of the image panel 30. By adjusting the brightness of the M×N barrier regions formed at each pixel 31, a 3D image may be more exactly displayed to an observer, depending on the observer's position and distance. For example, the barrier regions may be controlled in an M×N×L scheme. M×L represents the number of barrier regions per pixel, and L represents brightness in each barrier region.

In accordance with an exemplary embodiment, the number M of rows and the number N of columns in the M×N barrier regions are equal to or greater than 1. As one example, the number N of the columns in the M×N barrier regions may be equal to or greater than 2. The number M of the rows may also be equal to or greater than 2. Also, the number M of the rows may be greater than the number N of the columns. Since a human's eyes are located left and right, it is more efficient as more barriers are aligned in a column direction.

In this embodiment, the barrier panel 10 adjusts the brightness of the M×N barrier regions per pixel in L levels and is controlled in an M×N×L scheme. Therefore, a 3D image is displayed from the image panel 30 to an observer. When the brightness of the barrier regions is adjusted, left and right images of the image panel 30 may be more exactly displayed to the observer, even though an observer's position and distance move slightly.

In accordance with another exemplary embodiment, the brightness of the barrier regions may be controlled to have an on level, an off level, and at least one middle brightness level between the on level and the off level. In this case, L may be equal to or greater than 3 in the barrier region control using the M×N×L scheme. Referring to FIG. 2, the barrier regions #1, #2 and #3 exhibit different brightness levels. The barrier region #1 is a region in which a barrier is switched off and therefore an image of the image panel 30 is completely displayed to an observer. For example, the barrier region #3 is a region in which a barrier is switched off and therefore an image display of the image panel 30 is blocked. The barrier region #2 is a region that corresponds to a middle level between the barrier region #1 and the barrier region #3. In the barrier region #3, an image of the image panel 30 is displayed blurrily to an observer.

FIG. 1 shows one pixel 31 of an image panel (e.g., a 3D LCD) that is divided into M×N barrier regions. If a viewpoint is on the left, and a pixel of the image panel 30 under an M×N barrier set shows a left image, several barrier regions on the left of the M×N barrier regions are switched off to display an image, and several barrier regions on the right of the M×N barrier regions are switched on to block an image. Instead of switching on/off all regions on the pixel, as in the case of the fixed barrier scheme, one pixel of the liquid crystal panel is divided in many regions and an image is displayed or blocked according to a viewpoint.

In FIG. 2, the barrier panel may minimize loss of overlapped images by adjusting a transmission of a two-dimensional M×N matrix while the two-dimensional M×N matrix is being switched on/off. That is, the M×N barrier regions may have the L-level brightness. A driver for one barrier region may be controlled with an L-bit depth. In this case, the M×N barrier regions per one pixel 31 of the liquid crystal panel may have 2×L brightness. Specifically, if L is the bit number of brightness, not the brightness level, an M×N×2L matrix control may be achieved.

As one example, if the barrier regions are controlled using a 2-bit control signal, they may have 4-level brightness L, from the barrier-on to the barrier-off. If expressed in the M×N×L scheme, L becomes 4.

In accordance with an exemplary embodiment, the barrier forms the M×N barrier regions per one pixel of the liquid crystal panel. Each barrier region may include a liquid crystal cell. As one example, the barrier panel 10 may be an active matrix type barrier panel in which a plurality of liquid crystal cells each includes a thin film transistor (TFT) and a storage capacitor. Also, the barrier panel 10 may be a passive matrix type barrier panel in which a liquid crystal cell is formed in an intersection region of a row electrode and a column electrode. The active matrix type barrier panel may be driven based on a method of driving a typical TFT LCD, and the passive matrix type barrier panel may be driven based on a method of driving a typical passive matrix LCD. In the barrier panel 10, as shown in FIG. 2, the brightness of the liquid crystal cell in each barrier region may be changed by a driving signal generated by a control unit 50 of the image display device. For example, the liquid crystal cell may be changed to an opaque cell, a transparent cell, or a translucent cell.

In accordance with the exemplary embodiment of the present invention, the M×N barrier regions per one pixel of the liquid crystal panel are controlled in the M×N×L matrix type by adjusting the barrier regions in the L brightness levels. Therefore, a glassless multi-view 3D image may be implemented properly according to ambient brightness, power dissipation, and the number of observers. In particular, if there are multiple observers, one pixel is controlled in the M×N×L matrix type, thereby providing a proper 3D image to each observer.

In addition, the brightness L of each M×N barrier region per one pixel of the liquid crystal panel may be adjusted. Therefore, dizziness in the two-eye intersection region may be minimized. In particular, a 3D image may be displayed, without regard to the rotation of the liquid crystal panel.

A 3D image display device in accordance with a second embodiment of the present invention will be described below in detail with reference to the accompanying drawings. The description about the second embodiment of the present invention will be made with reference to the above-mentioned embodiment of the barrier panel and FIG. 1, and redundant descriptions will be omitted.

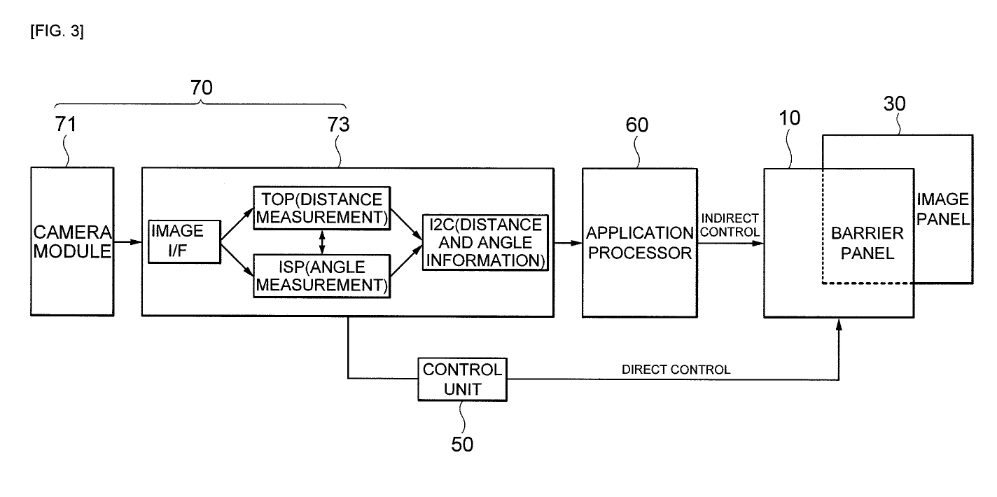

FIG. 2 is a schematic view of a 3D image display device in accordance with another embodiment of the present invention, and FIG. 3 is a block diagram of a 3D image display device in accordance with another embodiment of the present invention.

An image display device in accordance with an embodiment of the present invention will be described below with reference to FIG. 2. Referring to FIG. 2, an image display device in accordance with an embodiment of the present invention includes an image panel 30, a barrier panel 10, and a control unit 50.

The image panel 30 includes a plurality of pixels and displays a 3D image. As one example, the image panel 30 may include a plurality of liquid crystal cells. Since the image panel 30 including a plurality of liquid crystal cells is well known, a detailed description thereof will be omitted.

In FIG. 2, the barrier panel 10 is disposed in the front or rear side of the image panel 30. In addition, the barrier panel 10 is configured to form M×N barrier regions per one pixel of the image panel 30. Furthermore, in accordance with an exemplary embodiment of the present invention, the barrier panel 10 includes M×N barrier regions per pixel, in which the number M of rows and the number N of columns are equal to or greater than 1. Moreover, in accordance with an exemplary embodiment, the number M of the rows may be equal to or greater than 1, and the number N of the columns may be equal to or greater than 2. As one example, the number M of the rows may be greater than the number N of the columns.

The brightness of the barrier panel 10 shown in FIG. 2 may be adjusted according to each barrier region. For example, the brightness of the barrier panel 10 may be adjusted in L brightness levels. In this case, the barrier regions of each pixel may be adjusted in an M×N×L scheme.

In accordance with another exemplary embodiment, the barrier panel 10 may be controlled by the control unit 50 to have an on level, an off level, and at least one middle brightness level. That is, the brightness of the barrier regions may be controlled to have at least 3 levels. In this case, L is equal to or greater than 3 in the barrier region control using the M×N×L scheme. Referring to FIG. 2, the barrier regions #1, #2 and #3 exhibit different brightness levels. The barrier region #1 is a region in which a barrier is switched off and therefore an image of the image panel 30 is completely displayed to an observer. For example, the barrier region #3 is a region in which a barrier is switched off and therefore an image display of the image panel 30 is blocked. The barrier region #2 is a region that corresponds to a middle level between the barrier region #1 and the barrier region #3. In the barrier region #3, an image of the image panel 30 is displayed blurrily to an observer.

Referring again to FIG. 2, the control unit 50 adjusts the brightness of the barrier regions to display a 3D image from the image panel 30. For example, if the control unit 50 controls the barrier regions using a 2-bit control signal, the barrier regions may be adjusted to have 4-level brightness L, from the barrier-on to the barrier-off. In FIG. 2, the barrier panel 10 may minimize loss of overlapped images through the M×N matrix control performed by adjusting a transmission of a two-dimensional M×N matrix while the two-dimensional M×N matrix is being switched on/off. A driver for one barrier region may be controlled with an L-bit depth. In this case, the M×N barrier regions per one pixel 31 of the liquid crystal panel may have 2×L brightness levels.

In accordance with the exemplary embodiment of the present invention, the barrier regions per one pixel 31 of the image panel 30 are controlled in the M×N×L matrix type. Therefore, a glassless multi-view 3D image may be implemented properly according to ambient brightness, power dissipation, and the number of observers.

A 3D image display device in accordance with an exemplary embodiment of the present invention will be described in detail with reference to FIG. 3.

Referring to FIG. 3, the 3D image display device may include an image panel 30, a barrier panel 10, a control unit 50, and a tracking system 70.

The tracking system 70 of FIG. 3 acquires an image of an observer region and extracts observation position information of an observer.

The control unit 50 adjusts brightness of the barrier regions of the barrier panel 10 according to the observation position information, such that a 3D image of the image panel 30 is exposed to the observation position of the observer.

More specifically, as one example, the tracking system 70 includes a camera module 71 and a tracking unit 73. The camera module 71 acquires an image of an observer region. The tracking unit 73 uses an image to calculate a position and distance of an observer's two eyes as the observation position information. For example, in order to calculate the position of the observer's two eyes, the tracking unit 73 may extract a face region from an image region acquired by a camera, and more exactly calculate the position of the observer's two eyes by irradiating infrared light to the corresponding region. The tracking system 70 may perform the distance measurement using a Time Of Flight (TOF) scheme. Alternatively, the distance measurement may be performed using a front camera. For example, a stereo camera recognizes the distance of the observer's two eyes, and a front camera calculates a size of a currently photographed image as compared to a reference image. In this manner, the distance of the observer's two eyes may be extracted. Also, the distance measurement may be performed using infrared light. Other various methods may also be applied. In the case of using the infrared light, a voltage is changed at each region of an image, depending on an amount of emitted infrared light reflected from an object. Using this feature, the distance of the observer's two eyes may be measured. The method of calculating the distance and position of the object in the tracking system 70 is well known in the art to which the invention pertains.

The control unit 50 acquires a control value for controlling the brightness of each barrier region from the position and distance information of the observer's two eyes 10, and adjusts the brightness of each barrier region according to the acquired control value. As one example, the control value suitable according to the position and distance of the observer's two eyes may be calculated using a look-up table. Also, the control value according to the position and distance of the observer's two eyes may be calculated using a programmed equation.

Referring to FIG. 3, the M×N×L barrier control for one pixel 31 of the liquid crystal panel has information on the distance and angle of the LCD and the observer as input information. Using the image acquired by the camera module 71, information on the distance between the LCD and the observer, more specifically the observer's two eyes, may be obtained. Also, using viewpoint tracking, viewpoint angle information may also be obtained. As one example, the distance measurement may be performed using the TOF scheme. The distance measurement may be performed using a front camera. For example, a stereo camera recognizes the distance of the observer's two eyes, and a front camera calculates a size of a currently photographed image as compared to a reference image. Referring to FIG. 3, the control of the barrier may be directly performed using I2C, based on the above information. Also, this information may be transmitted to an application processor (AP), and the AP may transmit barrier control information, which is synchronized with an inputted 3D image, to the barrier panel 10. The AP controls a 3D image generator, a formatter, and a barrier on/off in a current 3D system. For example, in the case where the AP controls a display of a portable terminal, barrier control information (for example, position information, on/off information of each sub-pixel, and synchronization timing information) may be transmitted to the AP, and the AP may control the individual barriers according to the control information. In FIG. 3, I2C is a simple communication protocol for transmitting the control information and it is an interface (I/F) method that is most commonly used in a portable terminal. In FIG. 3, the control unit 50 uploads information, which is to be controlled by the control unit 50 itself, to the I2C protocol. In this case, the control unit 50 may put together the inputted information (for example, distance, and angle of the observer's two eyes with respect to the front direction) and determine which sub barrier of the LCD is to be switched on or off. Output information of the control unit 50 may be different according to the size of the LCD, the size of the sub barrier, and image speed.

In accordance with the exemplary embodiment, the filtering of the left and right images based on the observer's viewpoint is performed in connection with the barrier. Therefore, a phenomenon that an image is disappeared according to the movement of the viewpoint may be eliminated. Therefore, a perfect glassless multi-view 3D image may be displayed.

In the typical fixed barrier structure, a barrier needs to be disposed on a pixel exactly designated based on a calculation value. At this time, the calculation value is determined according to the distance between the observer or viewer and the LCD. For example, the calculation value is determined according to how far the observer or viewer is spaced apart from the portable terminal and how far the observer or viewer's two eyes are spaced apart. Even though the calculation value is determined, the 3D image looks overlapped if the 3D viewpoint of the barrier is not located at the calculated position. As a result, expensive equipment needs to be used to align the 3D image.

However, in accordance with the exemplary embodiment of the present invention, a barrier managing one liquid crystal panel pixel, for example, an LCD pixel, is divided into many regions. Therefore, even though the barrier is not located at an exact position, offsets between the barrier and the pixel are determined as many as the divided regions, and the brightness of the barrier is adjusted. Hence, as compared to the typical fixed barrier, a 3D effect with improved performance may be obtained. For example, if the first barrier is located at a position spaced apart by ¼ pixel on x-axis in LCD pixel x-y coordinates, a control algorithm is executed by adding all portions of the barrier control information to a value corresponding to the ¼ pixel, and the value may be transmitted to the AP or the barrier control unit 50.

A 3D image display method in accordance with a third embodiment of the present invention will be described in detail with reference to the accompanying drawings. The description about the third embodiment of the present invention will be made with reference to the above-mentioned embodiments of the barrier panel, the 3D image display device and FIGS. 1 to 3, and redundant descriptions will be omitted.

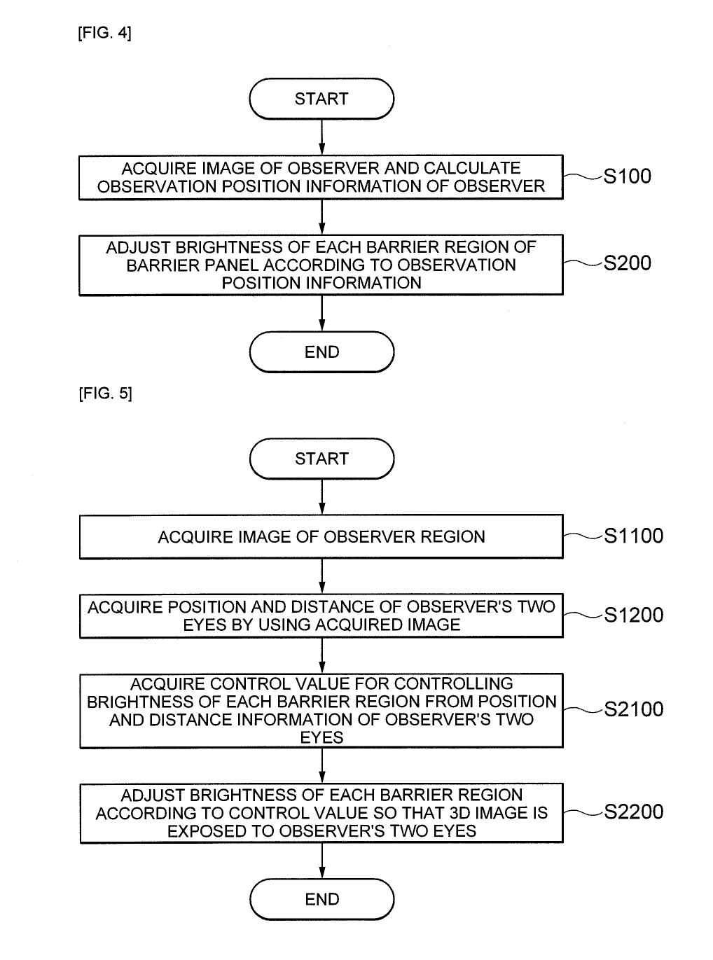

FIG. 4 is a flowchart showing a 3D image display method in accordance with an embodiment of the present invention, and FIG. 5 is a flowchart showing a 3D image display method in accordance with another embodiment of the present invention.

Referring to FIG. 4, the barrier panel 10 is disposed corresponding to the image panel 30 such that M×N barrier regions are formed at each pixel of the image panel 30 including a plurality of pixels, and brightness of each barrier region of the barrier panel 10 is adjusted according to position information of an observer. By adjusting the brightness of each barrier region, a 3D image is displayed from the image panel 30.

Hereinafter, the 3D image display method in accordance with the embodiment of the present invention will be described in more detail with reference to FIG. 4 and/or FIG. 5. The 3D image display method includes a position tracking step S100 and a barrier controlling step S200.

In the position tracking step S100 of FIG. 4, an image of an observer region is acquired, and observation position information of the observer is extracted.

Referring to FIG. 5, as another example, the position tracking step S100 includes a step S1100 of acquiring the image of the observer region and a step S1200 of acquiring a position and distance of an observer's two eyes as observation position information by using the acquired image.

In accordance with the exemplary embodiment, the M×N barrier regions per one pixel of the liquid crystal panel are controlled in an M×N×L matrix type by adjusting the M×N barrier regions in L brightness levels. Therefore, a glassless multi-view 3D image may be implemented properly according to ambient brightness, power dissipation, and the number of observers. In particular, if there are multiple observers, one pixel is controlled in the M×N×L matrix type, thereby providing a proper 3D image to each observer.

Referring again to FIG. 4, in the barrier controlling step S200, a 3D image of the image panel 30 is displayed to the observer by adjusting the brightness of each barrier region of the barrier panel 10, which is disposed corresponding to the front or rear side of the image panel 30, according to the observation position information.

Referring to FIG. 5, as another exemplary embodiment, the barrier controlling step S200 may include a step S2100 of acquiring a control value for controlling the brightness of each barrier region from the position and distance information of the observer's two eyes, and a step S2200 of adjusting the brightness of each barrier region to expose a 3D image of the image panel 30 to the observer's two eyes according to the control value.

As another exemplary embodiment, in the barrier controlling step S200 of FIG. 4, the brightness of the barrier regions may be controlled to have an on level, an off level, and at least one middle level between the on level and the off level. That is, the brightness of the barrier regions may be controlled in at least three levels.

In accordance with another exemplary embodiment, the barrier panel includes M×N barrier regions per pixel, in which the number M of rows and the number N of columns are equal to or greater than 1. As another example, the number M of the rows may be equal to or greater than 1, and the number N of the columns may be equal to or greater than 2. The number of the rows may be greater than the number N of the columns. In accordance with the exemplary embodiment, the barrier panel for the 3D image panel is divided into M×N barrier regions per one pixel of the image panel, and the brightness of the M×N barrier regions is adjusted. In this manner, a multi-view glassless 3D image display may be implemented.

In accordance with an exemplary embodiment of the present invention, an optimal image may be displayed by determining the distance and angle between the observer and the display panel during the control of the barrier panel. Furthermore, in the barrier panel, the brightness of the M×N barrier regions per pixel of the image panel may be adjusted according to the viewpoint angle and distance of the observer. Therefore, when the observer views the 3D image, dizziness or fatigue may be alleviated.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A barrier panel, characterized in that the barrier panel is disposed corresponding to an image panel including a plurality of pixels and is configured so that M×N barrier regions per pixel of the image panel are formed, wherein the brightness of each barrier region is respectively adjusted for a 3D image to be displayed from the image panel.

2. The barrier panel according to claim 1, wherein the brightness of each barrier region is controlled to have an on level, an off level, and at least one middle brightness level between the on level and the off level.

3. The barrier panel according to claim 1, wherein the number (M) of rows and the number (N) of columns in the M×N barrier regions are respectively equal to or greater than 1.

4. The barrier panel according to claim 3, wherein the number (N) of the columns in the M×N barrier regions is equal to or greater than 2.

5. A 3D image display device, which comprises:
an image panel configured to include a plurality of pixels and display an image for 3D image;
a barrier panel disposed in a front or rear side of the image panel and configured to include M×N barrier regions per pixel of the image panel, wherein brightness is adjusted by each barrier region; and
a control unit configured to adjust the brightness of each barrier region so that the 3D image is displayed from the image panel.

6. The 3D image display device according to claim 5, wherein the barrier panel is controlled by the control unit to have an on level, an off level, and at least one middle level, such that the brightness of each barrier region is adjusted in at least three levels.

7. The 3D image display device according to claim 5, wherein the number (M) of rows and the number (N) of columns in the M×N barrier regions are respectively equal to or greater than 1.

8. The 3D image display device according to claim 7, wherein the number (M) of the rows is equal to or greater than 1, and the number (N) of the columns is equal to or greater than 2.

9. The 3D image display device according to claim 5, which further comprises a tracking system configured to acquire an image of an observer region and extract observation position information of the observer,
wherein the control unit is configured to adjust the brightness of each barrier region of the barrier panel according to the observation position information so that the 3D image of the image panel is exposed to the observation position of the observer.

10. The 3D image display device according to claim 9, wherein:
the tracking system comprises:
a camera module configured to acquire the image of the observer region; and
a tracking unit configured to calculate a position(s) and distance(s) of the observer's two eyes as the observation position information by using the acquired image, and
the control unit is configured to acquire a control value for controlling the brightness of each barrier region from the position and distance information of the observer's two eyes and adjust the brightness of each barrier region according to the acquired control value.

11. A 3D image display method, characterized in that a 3D image is displayed from an image panel by adjusting brightness of M×N barrier regions formed in a barrier panel, based on position information of an observer, wherein the barrier panel is disposed corresponding to the image panel including a plurality of pixels so that the M×N barrier regions per pixel of the image panel are formed.

12. The 3D image display method according to claim 11, which comprises:
performing a position tracking step of acquiring an image of an observer region and extracting observation position information of the observer; and
performing a barrier controlling step of controlling that the 3D image of the image panel is displayed to the observer, by adjusting the brightness of each barrier region according to the observation position information, wherein the barrier panel is disposed corresponding to a front or rear side of the image panel.

13. The 3D image display method according to claim 12, wherein, in the barrier controlling step, the brightness of each barrier region is controlled to have an on level, an off level, and at least one middle level, such that the brightness of each barrier region is adjusted in at least three levels.

14. The 3D image display method according to claim 12, wherein:
the position tracking step comprises:
acquiring the image of the observer region; and
acquiring a position(s) and distance(s) of the observer's two eyes as the observation position information by using the acquired image, and
the barrier controlling step comprises:
acquiring a control value for controlling the brightness of each barrier region from the position and distance information of the observer's two eyes; and
adjusting the brightness of each barrier region according to the control value so that the 3D image of the image panel is exposed to the observer's two eyes.

15. The 3D image display method according to claim 11, wherein the barrier panel is configured to form M×N barrier regions per one pixel of the image panel, in which the number (M) of rows and the number (N) of columns in the M×N barrier regions are respectively equal to or greater than 1.
